(19) United States
(12) Patent Application Publication
(10) Pub. No.: US 2021/0264819 A1
(43) Pub. Date: Aug. 26, 2021

(54) SURFACE MOUNTING SYSTEM

(71) Applicant: Michael Mulhall, Irvine, CA (US)

(72) Inventor: Michael Mulhall, Irvine, CA (US)

(21) Appl. No.: 17/179,433

(22) Filed: Feb. 19, 2021

Related U.S. Application Data
(60) Provisional application No. 62/979,869, filed on Feb. 21, 2020.

(51) Int. Cl. G09F 3/10; G09F 3/20

(52) U.S. Cl. CPC G09F 3/10; G09F 3/20

(57) ABSTRACT

A surface mounting system and method can include: providing a magnet; coupling a sticker to the magnet, the sticker having an adhesive on a side opposite the magnet, the sticker with the adhesive having portions peripheral to the magnet, and the sticker for adhering the magnet to a surface; and magnetically coupling a fixture to the magnet.

### CROSS-REFERENCE TO RELATED APPLICATIONS

This claims priority benefit to all common subject matter of U.S. Provisional Patent Application 62/979,869 filed Feb. 21, 2020. The content of this applications is incorporated herein by reference.

### TECHNICAL FIELD

This disclosure relates to surface mounting technologies, more particularly to adjustable and removable surface mounting technologies.

### BACKGROUND

The rapidly growing market for digital prints represents one of the largest potential market opportunities for next generation artwork and interior décor. The ability to capture, edit, and transfer digital images has greatly expanded the industry by providing the ability to edit, order, and ship digital prints directly to one's home.

With the rise of a large plurality of online printers, the digital print industry has become highly competitive with little meaningful market differentiation. Even so, the rapid growth in the digital print industry has advanced in reliance on traditional surface mounting technologies.

These traditional surface mounting technologies are inherently problematic in many ways. Screws and nails, for example, leave holes in the surface which can be permanent or difficult to fully repair.

A further example would be double sided tape, which can mar a surface, leave residual adhesive, or even peel paint. Adhesive based technologies can fall off over time and typically stick to a limited number of wall types.

Not only do these traditional surface mounting techniques have a tendency to permanently damage a mounting surface, these traditional surface mounting techniques also provide little to no adjustability. Nails, screws, and adhesives need to be fixed with accuracy, without which, the mounting will be misaligned. Misalignment can require additional attempts at nailing, screwing, or adhering the mounting surface.

Damage to one's walls is regarded as the greatest concern to most consumers when mounting photos or artwork to their walls. Consequently, reducing or eliminating the damage to a mounting surface while affording flexibility to the placement of a digital print has been identified as a primary market differentiating feature for next generation surface mounting technologies.

In view of the ever-increasing commercial, technological, and consumer expectations and the diminishing opportunities for meaningful product differentiation in the marketplace, it is critical that surface mounting technologies eliminating surface damage while affording flexibility to placement and positioning be found. Solutions to these problems have been long sought, but prior developments have not taught or suggested any complete solutions and, thus, solutions to these problems have long eluded those skilled in the art.

### SUMMARY

A surface mounting system and methods, eliminating damage to a mounting surface and providing a high degree of flexibility in the placement of a mounted piece, are disclosed. The surface mounting system and methods can include: providing a magnet; coupling a sticker to the magnet, the sticker having an adhesive on a side opposite the magnet, the sticker with the adhesive having portions peripheral to the magnet, and the sticker for adhering the magnet to a surface; and magnetically coupling a fixture to the magnet.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The surface mounting system is illustrated in the figures of the accompanying drawings which are meant to be exemplary and not limiting, in which like reference numerals are intended to refer to like components, and in which:

FIG. 1 is a front view of the surface mounting system in a first embodiment.

FIG. 2 is a front view of the surface mounting system in a second embodiment.

FIG. 3 is a front view of the surface mounting system in a third embodiment.

FIG. 4 is a back view of the sticker of FIG. 1 in a pre-attachment phase.

FIG. 5 is a back view of the sticker of FIG. 1 in a peeled phase.

FIG. 6 is a cross-sectional view of the surface mounting system along the line 6-6 of FIG. 1.

FIG. 7 is a front isometric view of the sticker of FIG. 1 and the magnet of FIG. 1 in an attachment phase.

FIG. 8 is a front isometric view of the sticker of FIG. 1 and the magnet of FIG. 1 in a heat application phase.

FIG. 9 is a front isometric view of the sticker of FIG. 1 and the magnet of FIG. 1 in a removal phase.

FIG. 10 is a front view of a sticker in a fourth embodiment.

FIG. 11 is a back isometric view of a magnet for use with the sticker of FIG. 10.

FIG. 12 is a front isometric view of the sticker of FIG. 10 and the magnet of FIG. 11 in a magnet attachment phase.

FIG. 13 is a front view of the surface mounting system in a pre-arrangement phase.

FIG. 14 is a front view of the surface mounting system in a post-arrangement phase.

FIG. 15 is a control flow for manufacturing the surface mounting system.

### DETAILED DESCRIPTION

In the following description, reference is made to the accompanying drawings that form a part hereof, and in which are shown by way of illustration, embodiments in which the surface mounting system may be practiced. It is to be understood that other embodiments may be utilized and structural changes may be made without departing from the scope of the surface mounting system.

When features, aspects, or embodiments of the surface mounting system are described in terms of steps of a process, an operation, a control flow, or a flow chart, it is to be understood that the steps can be combined, performed in a different order, deleted, or include additional steps without departing from the surface mounting system as described herein.

The surface mounting system is described in sufficient detail to enable those skilled in the art to make and use the surface mounting system and provide numerous specific details to give a thorough understanding of the surface mounting system; however, it will be apparent that the surface mounting system may be practiced without these specific details.

In order to avoid obscuring the surface mounting system, some well-known system configurations and descriptions are not disclosed in detail. Likewise, the drawings showing embodiments of the system are semi-diagrammatic and not to scale and, particularly, some of the dimensions are for the clarity of presentation and are shown greatly exaggerated in the drawing FIGs. As used herein the term “coupled” or “coupling” means direct or indirect physical contact between coupled elements.

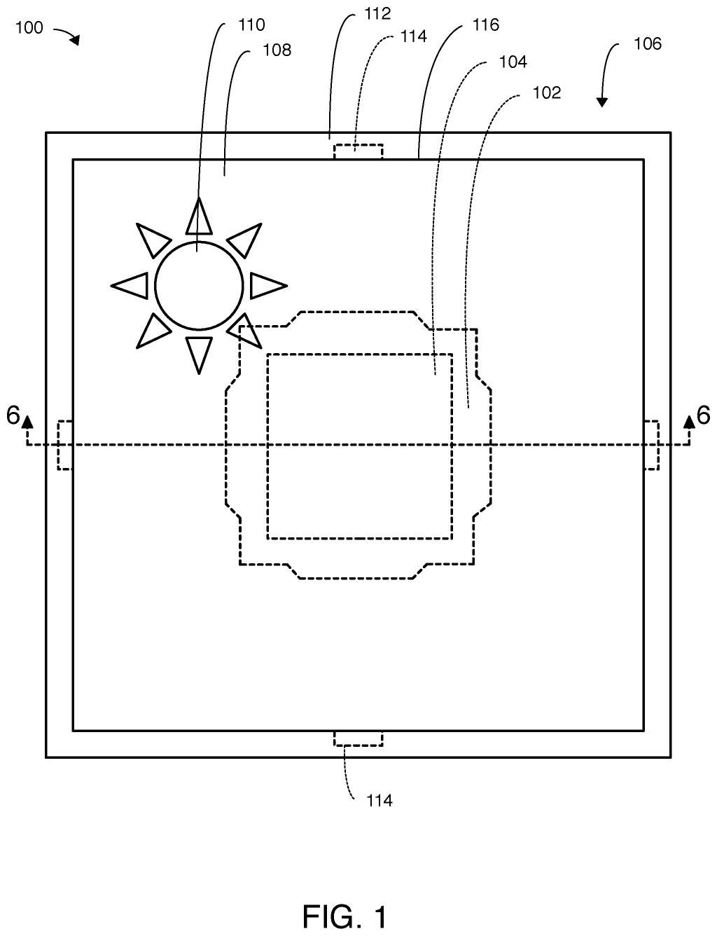

Referring now to FIG. 1, therein is shown a front view of the surface mounting system 100 in a first embodiment. The surface mounting system 100 is shown having a sticker 102 and a magnet 104 coupled thereto.

The magnet 104 can be adhered to the sticker 102, and the sticker 102 can be adhered to a surface 106. The surface 106 can be a wall, a door, a ceiling, or other surface for mounting the surface mounting system 100.

The surface 106 is contemplated to include many variations and can even include curved surfaces so long as the surface does not inhibit contact between the magnet 104 and a fixture 108. The fixture 108 can be magnetically coupled to, and in direct contact with, the magnet 104.

In the present embodiment, the fixture 108 is a magnetic tile and can be formed of steel or other materials incorporating ferrous or ferromagnetic elements such as iron, nickel, or cobalt for magnetically coupling with the magnet 104. The fixture 108 is shown as a decorative tile with an image 110 printed thereon.

It is contemplated that the fixture 108 can include other forms as well. Illustratively, the fixture 108 could be a decorative plate, a shelf, a flat panel display, or other fixture capable of being magnetically coupled to the magnet 104.

The fixture 108 can have an appendage 112 coupled thereto. The appendage 112 is depicted as a picture frame but could also be implemented as a shelf, light bar, or other structure able to be coupled to the fixture 108.

The appendage 112 can be coupled to the fixture 108 with a friction fitting, a clamp, or an adhesive. In the present embodiment, the appendage 112 is depicted with appendage magnets 114 magnetically coupling the appendage 112 to the fixture 108. The appendage magnets 114 are shown arranged as a set of four, with each of the appendage magnets 114 contacting an outer edge 116 or perimeter of the fixture 108.

The appendage 112 can therefore be removable and rotatable. When the fixture 108 is circular, the appendage magnets 114 can be placed at intervals allowing the appendage 112 to be rotated an exact amount based on the placement of the appendage magnets 114.

The appendage 112 can utilize less than four of the appendage magnets 114. Illustratively, it is contemplated that the appendage 112 can be coupled to the fixture 108 with one of the appendage magnets 114 at the top of the fixture 108. Further contemplated arrangements can include one of the appendage magnets 114 at the top and one of the appendage magnets 114 on each side, or just one of the appendage magnets 114 on each side.

The appendage magnets 114 allow the appendage 112 to be readily changed with no difficulty. The appendage 112 may contact the surface 106 in some situations. However, it will be appreciated that the preferred embodiment of the subject matter of the invention, the fixture 108 and the appendage 112 do not contact the surface 106 but are spaced apart from the surface 106 to prevent scuffing, scraping, or damaging the surface 106 by contact with the appendage 112 or the fixture 108.

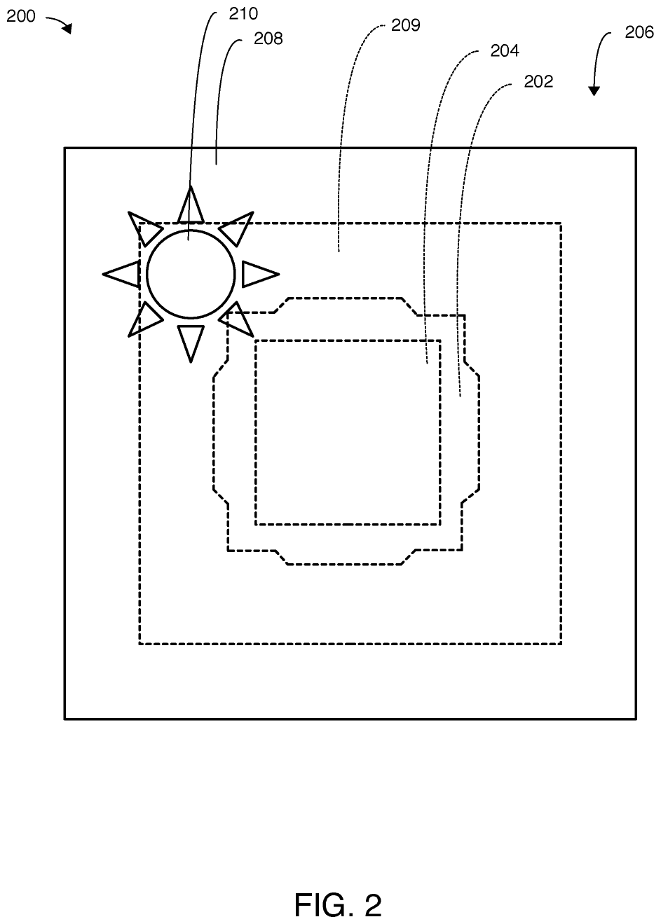

Referring now to FIG. 2, therein is shown a front view of the surface mounting system 200 in a second embodiment. The surface mounting system 200 is shown having a sticker 202 and a magnet 204 coupled thereto.

The magnet 204 can be adhered to the sticker 202, and the sticker 202 can be adhered to a surface 206. The surface 206 can be a wall, a door, a ceiling, or other surface for mounting the surface mounting system 200.

The surface 206 is contemplated to include many variations and can even include curved surfaces so long as the surface does not inhibit contact between the magnet 204 and a fixture 208. The fixture 208 can be magnetically coupled to, and in direct contact with, the magnet 204.

In the present embodiment, the fixture 208 is a non-magnetic tile and can be formed of acrylic aluminum or other non-magnetic materials. The fixture 208 is depicted with a magnetic backing plate 209 adhered on the back side of the fixture 208 facing the magnet 204.

It is contemplated that the magnetic backing plate 209 could be affixed to the back surface of the fixture 208 or could be incorporated into the fixture 208 through a molding process. The magnetic backing plate 209 can be formed of steel or other materials incorporating ferrous or ferromagnetic elements such as iron, nickel, or cobalt for magnetically coupling with the magnet 204. It is contemplated the magnetic backing plate 209 could be a magnetic polymer. The fixture 208 is shown as a decorative tile with an image 210 printed thereon.

It is contemplated that the fixture 208 can include other forms as well. Illustratively, the fixture 208 could be a decorative plate, a shelf, a flat panel display, or other fixture capable of being magnetically coupled to the magnet 204. It will be appreciated that the fixture 208 does not contact the surface 206 but is spaced apart from the surface 206 to prevent scuffing, scraping, or damaging the surface 206 by contact with the fixture 208.

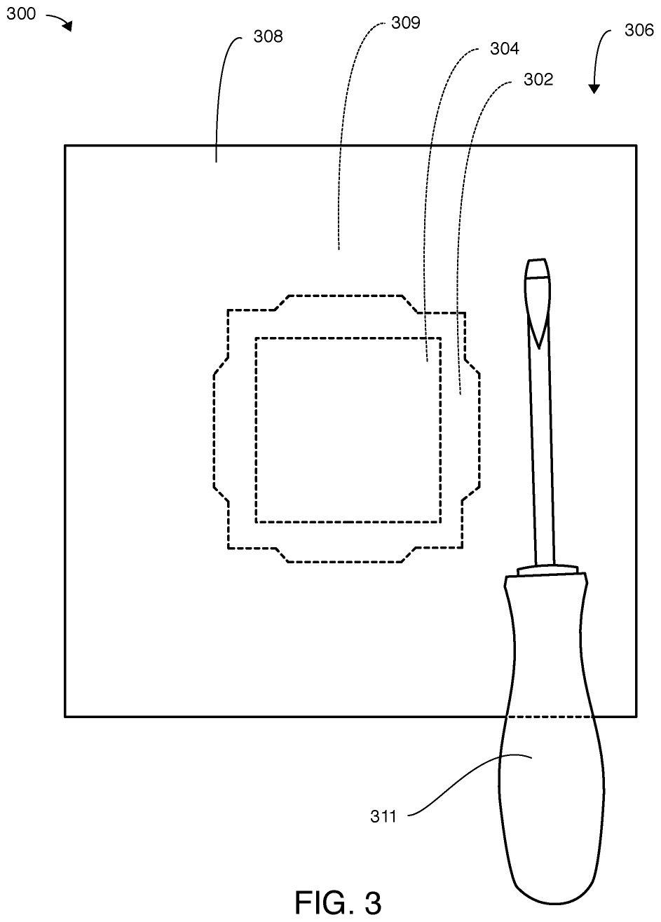

Referring now to FIG. 3, therein is shown a front view of the surface mounting system 300 in a third embodiment. The surface mounting system 300 is shown having a sticker 302 and a magnet 304 coupled thereto.

The magnet 304 can be adhered to the sticker 302, and the sticker 302 can be adhered to a surface 306. The surface 306 can be a wall, a door, a ceiling, or other surface for mounting the surface mounting system 300.

The surface 306 is contemplated to include many variations and can even include curved surfaces so long as the surface does not inhibit contact between the magnet 304 and a fixture 308. The fixture 308 can be magnetically coupled to, and in direct contact with, the magnet 304.

In the present embodiment, the fixture 308 is a tile that is a magnet itself, which is formed as a permanent magnet similar to the magnet 304. The fixture 308 can be a permanent ferrous or a rare earth magnet, for example. The fixture 308 can be magnetically coupled to the magnet 304.

The fixture 308, being a magnet, can be magnetically coupled to magnetic elements 311. The magnetic elements 311 can be formed of steel or other materials incorporating ferrous or ferromagnetic elements such as iron, nickel, or cobalt for magnetically coupling with the fixture 308.

It is contemplated that the fixture 308, when implemented as a magnet, provides greater organizational flexibility and a larger surface area for organizing the magnetic elements 311. It is contemplated that the magnetic elements 311 can be tools, knives, pins, nails, or other similar elements. It will be appreciated that the fixture 308 does not contact the surface 306 but is spaced apart from the surface 306 to prevent scuffing, scraping, or damaging the surface 306 by contact with the fixture 308.

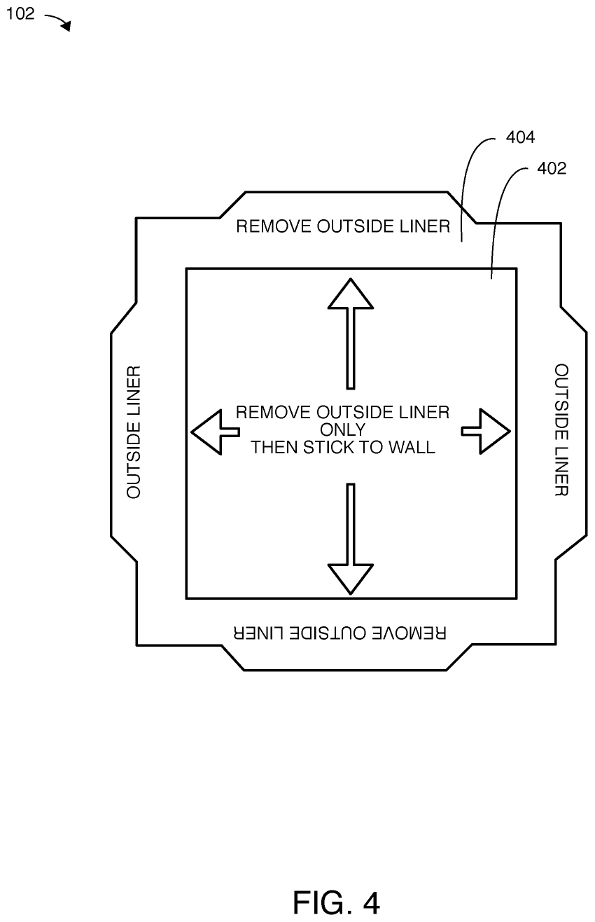

Referring now to FIG. 4, therein is shown a back view of the sticker 102 of FIG. 1 in a pre-attachment phase. The sticker 102 is shown having an inner liner 402 and an outer liner 404.

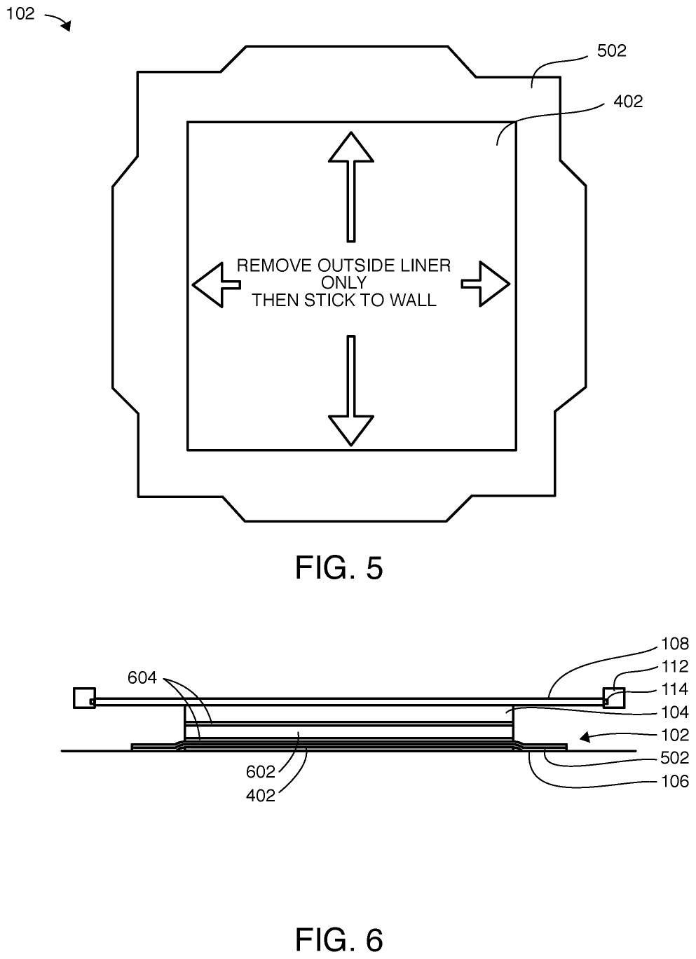

The inner liner 402 can protect the surface 106 of FIG. 1 from the adhesive 502 of FIG. 5 of the sticker 102. That is, the inner liner 402 can be placed between the adhesive 502 of the sticker 102 and the surface 106. The magnet 104 of FIG. 1 can be mounted to the opposite side of the sticker 102 from the inner liner 402.

Referring now to FIG. 5, therein is shown a back view of the sticker 102 of FIG. 1 in a peeled phase. The outer liner 404 of FIG. 4 has been removed revealing an adhesive 502 around the inner liner 402.

The adhesive 502 can fix the sticker 102 to the surface 106 of FIG. 1 while the inner liner 402 prevents the middle portion of the sticker 102 from being adhered directly to the surface 106.

Referring now to FIG. 6, therein is shown a cross-sectional view of the surface mounting system 100 along the line 6-6 of FIG. 1. The sticker 102 is shown having the outer liner 404 of FIG. 4 removed and the adhesive 502, peripheral to the magnet 104, affixed to the surface 106.

As shown, the adhesive 502 is prevented from contacting the surface 106 by the inner liner 402 still attached to the sticker 102 between the surface 106 and the adhesive 502. The sticker 102, having the adhesive 502 on a side opposite the magnet 104 and having portions of the sticker 102 and the adhesive 502 peripheral to the magnet, can be pressed down onto the surface 106 around and peripheral to the magnet 104 to ensure a proper attachment to the surface 106 without making removal difficult.

Furthermore, as will be appreciated, the use of the adhesive 502 peripheral to the magnet 104 allows for the application of heat for removal, similar to what is shown in FIG. 8. Utilizing the adhesive 502 opposite the magnet 104 would make removal more difficult as this adhesive 502 would be more difficult to apply heat to, and the larger surface coverage would increase adhesion.

The magnet 104 can be coupled to the sticker 102 with a stand-off layer 602 therebetween. The stand-off layer 602 can be a foam layer for providing a slight amount of give between the surface 106 and the fixture 108 in order to prevent damage to the surface 106.

The stand-off layer 602 can further be implemented as a plastic, metal, or natural material like wood or cardboard. The stand-off layer 602 can provide a stand-off height from the surface 106 for ensuring the fixture 108 and any appendages 112, for example, do not make contact with the surface 106.

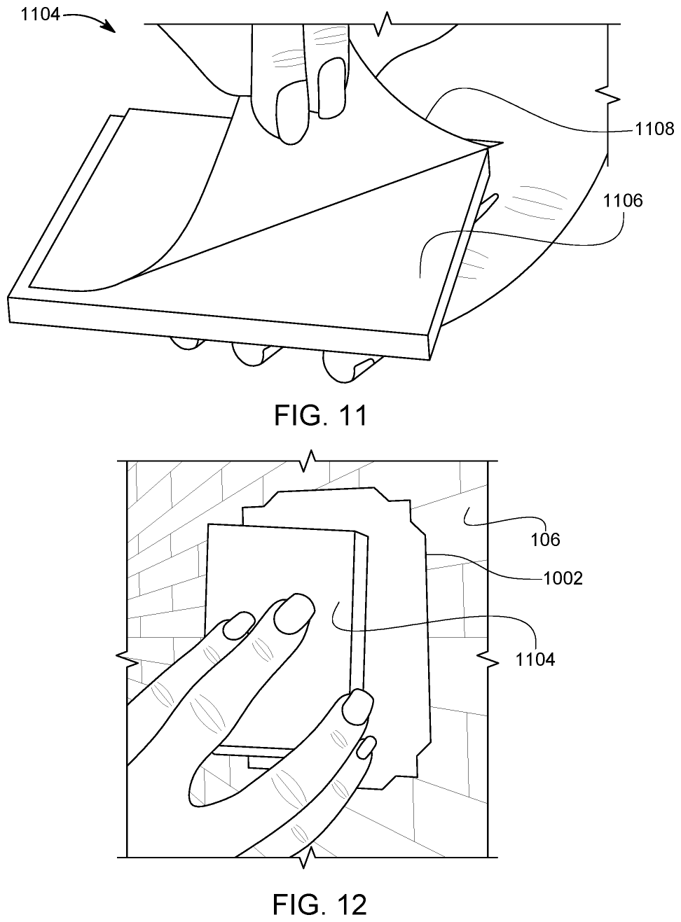

The magnet 104 can be affixed to the stand-off layer 602 and the stand-off layer 602 affixed to the sticker 102 with adhesive layers 604. In some contemplated embodiments, such as the embodiment depicted in FIGS. 11 and 12, the stand-off layer 602 can be eliminated and the magnet 104 can be affixed to the sticker 102 with a single adhesive layer 604.

The fixture 108 is shown magnetically coupled to the magnet 104 with a stand-off distance from the surface 106. The appendage 112 is shown coupled to the fixture 108 around the perimeter of the fixture 108.

The appendage 112 is shown coupled to the fixture 108 with the appendage magnets 114. The fixture 108 together with the appendage 112 can be repositioned in relation to the sticker 102 and the magnet 104 without remounting the sticker 102 allowing for fast, easy, and accurate mounting and arrangement of the fixture 108. Once the fixture 108 is no longer required, the sticker 102 can be easily removed by pealing the adhesive 502 and the sticker 102 peripheral to the magnet 104, which can be aided by the application of heat.

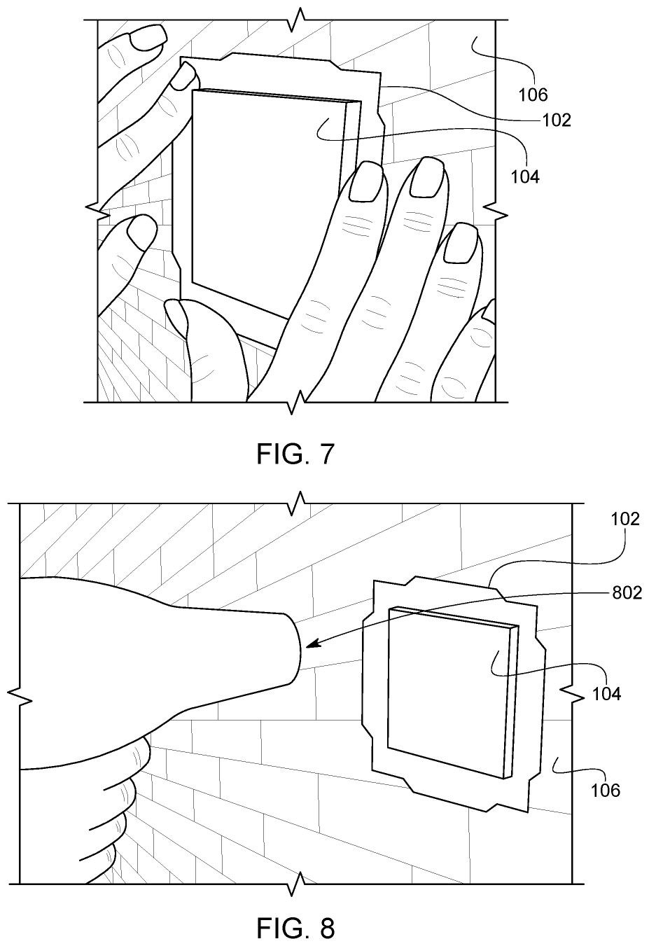

Referring now to FIG. 7, therein is shown a front isometric view of the sticker 102 of FIG. 1 and the magnet of FIG. 1 in an attachment phase. The sticker 102, when being attached, should have the outer liner 404 of FIG. 4 peeled off exposing the adhesive 502 of FIG. 5 from around the inner liner 402 of FIG. 4.

The sticker 102 can be pressed onto the surface 106 around the magnet 104. The adhesive 502 will not attach the sticker 102 to the surface 106 opposite the magnet 104. Rather the adhesive 502 will contact the surface 106 only peripheral to the magnet 104 for ease of removal.

Referring now to FIG. 8, therein is shown a front isometric view of the sticker of FIG. 1 and the magnet of FIG. 1 in a heat application phase. The sticker 102 can be heated peripheral to the magnet 104 in order to soften the adhesive 502 of FIG. 5 for removal.

The inner liner 402 of FIG. 4 protects the surface 106 from the adhesive 502, ensuring only the adhesive 502 peripheral to the magnet 104 touches the surface 106. This allows the sticker 102 to be removed easily by applying heat 802 only to the portion of the sticker 102 peripheral to the magnet 104, which is readily accessible and unlike the adhesive 502 opposite the magnet 104.

The heat 802 can loosen the adhesive 502 and allow the sticker 102 and the magnet 104 to be removed from the surface 106 easily without leaving any marks, torn paint, or pieces of the sticker 102.

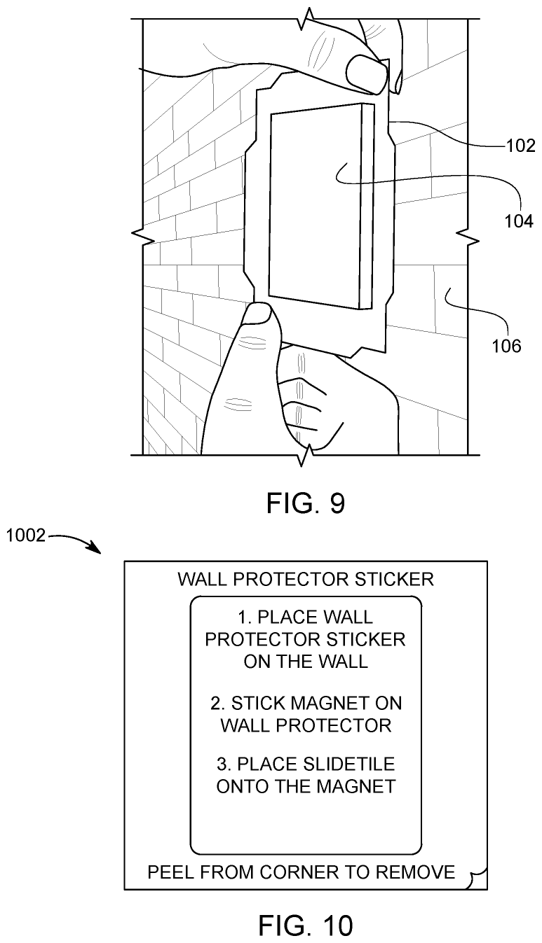

Referring now to FIG. 9, therein is shown a front isometric view of the sticker of FIG. 1 and the magnet of FIG. 1 in a removal phase. The sticker 102 can be removed by simply peeling around the edges of the sticker 102, as the inner liner 402 of FIG. 4 prevents the adhesive 502 of FIG. 5 from contacting the surface 106.

Rather, the adhesive 502 only contacts the surface 106 peripheral to the magnet 104. Removal can be aided by the application of the heat 802 of FIG. 8. As will be appreciated, the sticker 102 and the magnet 104 can be removed without damaging, marring, or scuffing the surface 106.

Referring now to FIG. 10, therein is shown a front view of a sticker 1002 in a fourth embodiment. The sticker 102 can include an inner liner and an outer liner similar to those of FIG. 4. The sticker 102 can also include the adhesive, such as the adhesive 502 of FIG. 5.

Referring now to FIG. 11, therein is shown a back isometric view of a magnet 1104 for use with the sticker 1002 of FIG. 10. The magnet 1104 is shown having an adhesive layer 1106 applied thereto. The adhesive layer 1106 can be covered with a protective layer 1108, which should be removed prior to mounting the magnet 1104 to the sticker 1002 as is shown in FIG. 12.

Referring now to FIG. 12, therein is shown a front isometric view of the sticker 1002 of FIG. 10 and the magnet 1104 of FIG. 11 in a magnet attachment phase. The magnet 1104 can be placed in the middle of the sticker 1002 for adhering the magnet 1104 to the surface 106. It is contemplated that an adhesive, such as the adhesive 502 of FIG. 5 can be in contact with the surface 106 and the sticker 1002 only peripheral to the magnet 1104 and not opposite the magnet 1104 for ease of removal.

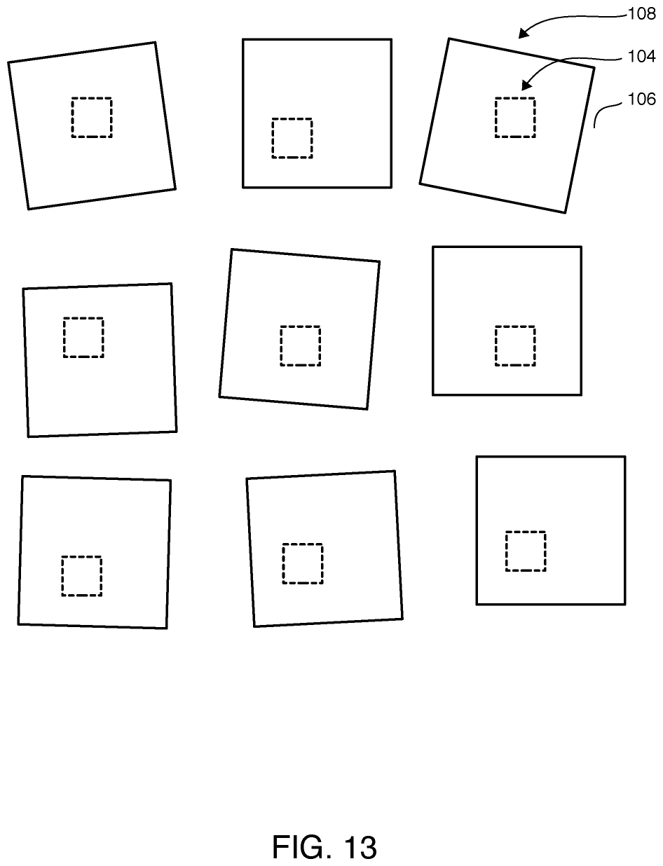

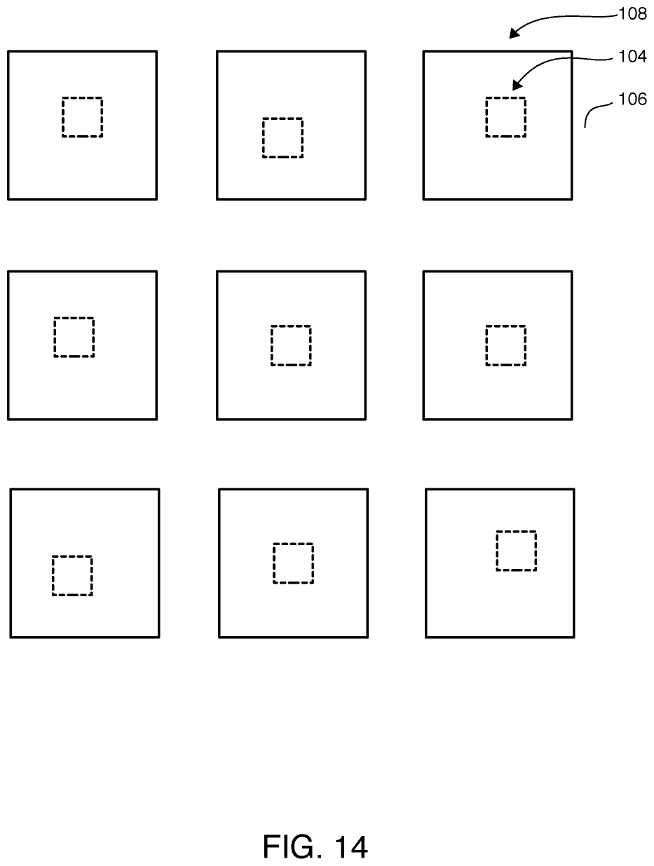

Referring now to FIG. 13, therein is shown a front view of the surface mounting system in a pre-arrangement phase. For descriptive clarity the pre-arrangement phase of FIG. 13 and the post-arrangement phase of FIG. 14 will be described with regard to the magnet 104 of FIG. 1 and the fixture 108 of FIG. 1; however, it is to be understood that the pre-arrangement phase and the post-arrangement phase can be performed with the other disclosed embodiments as well. Furthermore, multiple magnets 104 are shown supporting multiple fixtures 108 on the surface 106 and it is to be understood, in both the pre-arrangement phase and the post-arrangement phase, that each of the magnets 104 is affixed to the surface 106 with the sticker 102 of FIG. 1 or the sticker 1002 of FIG. 10, as described above and the sticker 102 is only omitted for clarity.

As an important feature of the surface mounting system, the magnets 104 can be mounted to the surface 106 without precise measurements. As is depicted, the magnets 104 are not aligned or properly spaced out. Furthermore, the fixtures 108 are not centered on the magnets 104.

This configuration can be done quickly by estimating the final desired position of the fixtures 108 and without exact measurements. This provides very quick and adjustable mounting.

Referring now to FIG. 14, therein is shown a front view of the surface mounting system in a post-arrangement phase. The fixtures 108 have been aligned and spaced with reference to each other, which can be accomplished quickly by simply moving the fixtures 108 around on the magnets 104.

The fixtures 108 are not centered on the magnets 104, nor are the magnets 104 aligned or spaced with reference to each other. As will be appreciated, the position of the magnets 104 allows the magnets 104 to be mounted quickly and then the fixtures 108 to be arranged more neatly later. Furthermore, the fixtures 108 can be changed, rearranged, or repositioned extremely easily.

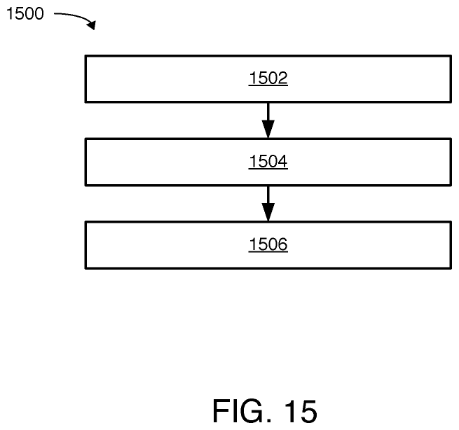

Referring now to FIG. 15, therein is shown a method 1500 for manufacturing the surface mounting system. The method 1500 for manufacturing the surface mounting system can include: providing a magnet in a block 1502; coupling a sticker to the magnet, the sticker having an adhesive on a side opposite the magnet, the sticker with the adhesive having portions peripheral to the magnet, and the sticker for adhering the magnet to a surface in a block 1504; and magnetically coupling a fixture to the magnet in a block 1506.

Thus, it has been discovered that the surface mounting system furnishes important and heretofore unknown and unavailable solutions, capabilities, and functional aspects. The resulting configurations are straightforward, cost-effective, uncomplicated, highly versatile, accurate, and effective, and can be implemented by adapting known components for ready, efficient, and economical manufacturing, application, and utilization.

The surface mounting system is directed toward images and graphics on metal and non-metal fixture material combined with a modular mounting system which allows the user to easily hang, adjust, and rearrange pictures utilizing a magnetic connection that provides damage free mounting to walls. For example, images are imprinted onto fixtures that are magnetically receptive such as steel or any ferromagnetic material, and which allow for damage free mounting to walls and allow for the use of removable appendages like magnetic picture frames.

The surface mounting system greatly reduces the difficulty and time it takes to mount multiple pieces of art together in a uniform way. Having the ability to adjust the artwork in any direction without having to re-mount it to the wall, users can place several pieces in close proximity to one another in a uniform way.

And because the artwork can be adjusted after mounting, little measurement is needed beforehand and takes only a fraction of the time to complete. Interchangeability of artwork and accessories that accentuate the art or photo is an additional benefit.

Because the artwork can easily be separated from the magnetic mounting system without having to remove the mounting system from the wall, the artwork is easily interchangeable. And because the fixture material can be ferromagnetic, frames and other appendages can be applied and connected to the fixture in an interchangeable fashion.

In another embodiment, the surface mounting system includes the ability to adhere a thin magnetic backing plate, such as steel or any other ferromagnetic material, to the back of another non-magnetic substrate such as acrylic, wood, aluminum, foam, or glass, which allows that substrate to also be magnetically mounted to the wall.

Another benefit discovered when implementing the surface mounting system is that modular accessories, such as the appendages, can attach to the magnetically receptive fixtures, and which can be easily removed, replaced, and interchanged with other modular appendages. With all the previously described benefits, one additional benefit has been discovered, which is that the surface mounting system provides a durable mounting, not only in the way the sticker and magnet are adhered to a surface, but in the way that the sticker does not need to be repositioned and multiple different fixtures can be arranged thereon, resulting in longevity of the mounting.

While the surface mounting system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. A surface mounting system comprising:
a magnet;
a sticker coupled to the magnet, the sticker having an adhesive on a side opposite the magnet, the sticker with the adhesive having portions peripheral to the magnet, and the sticker for adhering the magnet to a surface; and
a fixture magnetically coupled to the magnet.

2. The system of claim 1 wherein the sticker includes an inner liner, the inner liner positioned to prevent the adhesive from contacting the surface between the magnet and the surface.

3. The system of claim 1 further comprising an appendage coupled to the fixture.

4. The system of claim 3 wherein the appendage is coupled to the fixture with an appendage magnet.

5. The system of claim 1 wherein the fixture includes an image printed thereon.

6. A surface mounting system comprising:
a magnet with an adhesive layer coupled thereto;
a sticker coupled to the magnet with the adhesive layer, the sticker having an adhesive on a side opposite the magnet, the sticker with the adhesive having portions peripheral to the magnet, and the sticker for adhering the magnet to a surface; and
a fixture magnetically coupled to the magnet with a stand-off distance from the surface.

7. The system of claim 6 wherein the fixture is a permanent magnet.

8. The system of claim 6 wherein the fixture includes a magnetic backing plate affixed thereto.

9. The system of claim 6 wherein the fixture is a magnetic material.

10. The system of claim 6 wherein the magnet is coupled to the sticker with a stand-off layer therebetween.

11. A method of manufacturing a surface mounting system comprising:
providing a magnet;
coupling a sticker to the magnet, the sticker having an adhesive on a side opposite the magnet, the sticker with the adhesive having portions peripheral to the magnet, and the sticker for adhering the magnet to a surface; and
magnetically coupling a fixture to the magnet.

12. The method of claim 11 wherein coupling the sticker includes coupling the sticker having an inner liner, the inner liner positioned to prevent the adhesive from contacting the surface between the magnet and the surface.

13. The method of claim 11 further comprising coupling an appendage to the fixture.

14. The method of claim 13 wherein coupling the appendage includes coupling the appendage to the fixture with an appendage magnet.

15. The method of claim 11 wherein magnetically coupling the fixture includes magnetically coupling the fixture having an image printed thereon.

16. The method of claim 11 wherein:
providing the magnet includes providing the magnet with an adhesive layer coupled thereto;
coupling the sticker to the magnet includes coupling the sticker to the magnet with the adhesive layer; and
magnetically coupling the fixture to the magnet includes magnetically coupling the fixture to the magnet with a stand-off distance from the surface.

17. The method of claim 16 wherein magnetically coupling the fixture to the magnet includes magnetically coupling the fixture formed as a permanent magnet.

18. The method of claim 16 wherein magnetically coupling the fixture to the magnet includes magnetically coupling the fixture having a magnetic backing plate affixed thereto.

19. The method of claim 16 wherein magnetically coupling the fixture to the magnet includes magnetically coupling the fixture being a magnetic material.

20. The method of claim 16 wherein coupling the sticker to the magnet includes coupling the sticker to the magnet with a stand-off layer therebetween.
